(19) United States
(12) Patent Application Publication
(10) Pub. No.: US 2008/0059720 A1
(43) Pub. Date: Mar. 6, 2008

(54) System and method to enable prioritized sharing of devices in partitioned environments

(76) Inventors: Michael A. Rothman, Sammamish, WA (US); Vincent J. Zimmer, Federal Way, WA (US)

Correspondence Address: INTEL CORPORATION;c/o INTELLEVATE, LLC, P.O. BOX 52050, MINNEAPOLIS, MN, 55402, US

(21) Appl. No.: 11/517,195

(22) Filed: Sep. 5, 2006

(51) Int. Cl. G06F 12/00

(52) U.S. Cl. 711/153

(57) ABSTRACT

A system and method for enabling prioritized sharing of devices in partitioned environments. The method includes enabling I/O (Input/Output) requests from the partitions to be routed to a resource arbiter. The resource arbiter receives, from a partition, an I/O request for a device to be shared across partitions. The resource arbiter determines whether the device associated with the I/O request is busy. If the device is not busy, the resource arbiter sets a busy flag for the device and processes the I/O request. If the device is busy, the resource arbiter determines whether the device allows for interleaved access. If the device allows for interleaved access, then the resource arbiter queues the I/O request so that the I/O request can be processed using interleaved access. If the device does not allow for interleaved access, and platform policy dictates partition overrides of device locks based on priority rankings of the partition, the resource arbiter overrides the busy signal of the device and processes the I/O request if the requesting partition has a higher priority ranking.

### BACKGROUND OF THE INVENTION

1. Field of the Invention

The present invention is generally related to partitioning in computer systems. More particularly, the present invention is related to a system and method for enabling prioritized sharing of devices in partitioned environments.

2. Description

Partitioning requires the strict isolation of devices from one partition to another. In fact, with traditional hardware-based partitioning schemes, components of a partition are physically wired such that the components are not in communication with any other partitions in the scheme. Each partition has its own dedicated resources. Thus, the sharing of devices amongst partitions is prohibited. With such an isolation scheme, redundancy occurs when a device is needed by more than one partition. In other words, multiple devices of the same kind are implemented in one system in order for each partition in the system having a need for that device to be able to access the device. With the advent of having multiple core processors on a single silicon substrate and the inability to share devices across partitions, the redundancy of devices needed by each partition on a platform may add tremendous costs to the platform.

Thus, what is needed is a system and method to enable sharing of devices in a partitioning scheme. What is also needed is a system and method to enable prioritized sharing of devices in a partitioning scheme without having to add unnecessary cost for the redundancy of devices. What is further needed is a system and method that implements the usage of platform resources as soft-configurable partitions to enable priority-based sharing of devices while avoiding unnecessary duplication of devices as well as providing the reliability and availability of devices that is inherent to the concept of having a dedicated sequestered partition.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an exemplary platform topology of a soft-configurable partitioning environment enabling device sharing across partitions according to an embodiment of the present invention.

FIG. 2 is a block diagram illustrating an embodiment of the present invention in an exemplary virtualized environment.

FIG. 3 is a flow diagram describing an exemplary method for enabling the sharing of devices across partitions according to an embodiment of the present invention.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” or “in an embodiment” appearing in various places throughout the specification are not necessarily all referring to the same embodiment.

Embodiments of the present invention are directed to a system and method for enabling prioritized sharing of devices in a partitioning environment. By enabling partition schemes that allow priority-based sharing of devices, embodiments of the present invention avoid the unnecessary duplication of hardware devices, as well as provide the reliability and availability of resources that are inherent to the concept of having a dedicated sequestered partition. Embodiments of the present invention also enable interleaved access of certain classes of I/O (Input/Output) devices in a seamless manner. This is accomplished using a resource arbiter in a virtualization or Platform Resource Layer (PRL).

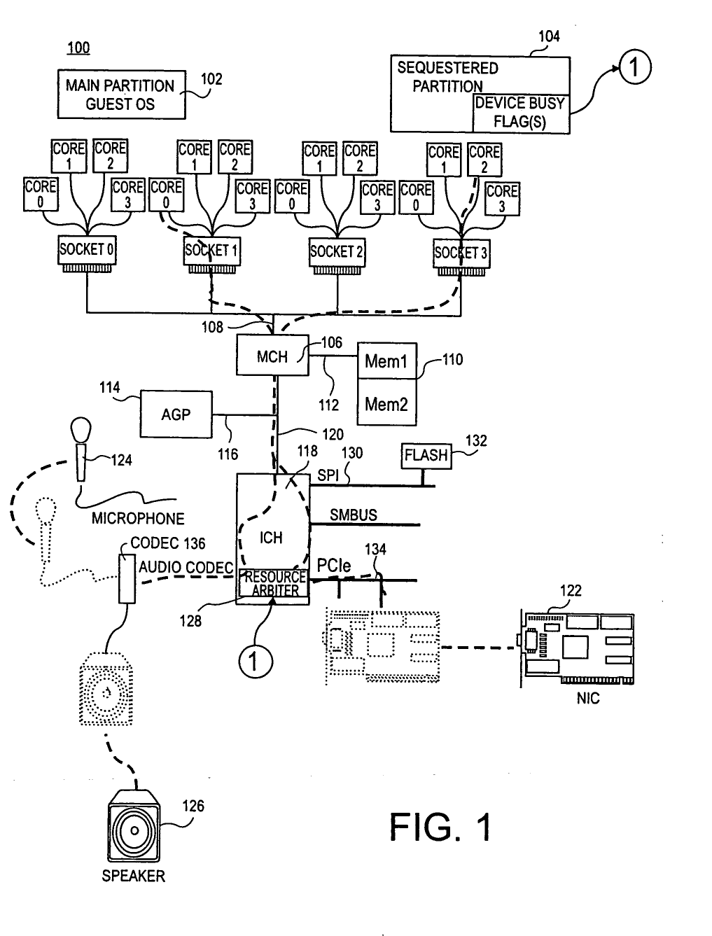

Embodiments of the present invention may be implemented using hardware, software, or a combination thereof and may be implemented in one or more multi-core processor platforms or other single-core processing systems. In fact, in one embodiment, the invention is directed toward one or more multi-core processor platforms capable of carrying out the functionality described herein. FIG. 1 illustrates an example implementation of a platform topology for a soft-configurable partitioning scheme 100 according to an embodiment of the present invention. Various embodiments are described in terms of this exemplary partitioning scheme 100. After reading this description, it will be apparent to a person skilled in the relevant art(s) how to implement the invention using other partitioning schemes and/or other computer architectures. For example, embodiments of the present invention are described using two partitions for simplicity. One skilled in the relevant art(s) would know that an implementation of an embodiment of the present invention having more than two partitions may be used as well.

Partitioning scheme 100 comprises a main partition 102 and a sequestered partition 104. In one embodiment, main partition 102 and sequestered partition 104 are unaware that they co-exist. In other words, main partition 102 may not be aware of sequestered partition 104 and vice versa. Each partition (102, 104) has a plurality of multi-core processors on at least one socket. For example, main partition 102 includes a plurality of multi-core processors (cores 0-3) on sockets 0, 1, and 2, and a single core processor (core 0) on socket 3. Main partition 102 may also allow multiple OSs (Operating Systems) as guests of main partition 102. For example, main partition 104 may allow a Windows OS and a Linux OS to run concurrently on different dedicated core processors of main partition 102 without either OS knowing that the other exists. Sequestered partition 104 includes multi-core processors (cores 1, 2, and 3) on socket 3. Thus, socket 3 receives data from main partition 102 and sequestered partition 104 while sockets 0, 1, and 2 receive data from main partition 102. Each core processor is a complete and functional processor designed into its corresponding socket.

In an embodiment, one or more core processors may be used to accomplish a specific functionality. For example, sequestered partition 104 having core processors 1, 2, and 3 on socket 3 may be dedicated to an embedded IT (Information Technology) to update and maintain the platform while main partition 102 having multi-core processors 0-3 on sockets 0, 1, and 2 and single core processor 0 on socket 3 may be dedicated to normal user operations of the platform. In other embodiments, the functionality of multi-core processors on sockets 0, 1, and 2, and single core processor 0 on socket 3 of main partition 102 may be used for multiple functions as well. For example, multi-core processors on sockets 0 and 1 may be dedicated to running applications resident in memory while multi-core processors on socket 2 and single-core processor 0 on socket 3 may be used for Internet/Intranet use or as an offload engine.

Each core processor (core 0, core 1, core 2, and core 3) on sockets 0, 1, 2, and 3 communicates with a memory controller hub (MCH) 106, also known as a North bridge, via a front side bus 108. MCH 106 communicates with system memory 110 via a memory bus 112. System memory 110 is partitioned into two parts, Mem 1 and Mem 2. Mem 1 is used to store data for main partition 102 and Mem 2 is used to store data for sequestered partition 104. MCH 106 recognizes the partitioning and will route memory requests from main partition 102 to Mem 1 and memory requests from sequestered partition 104 to Mem 2. MCH 106 may also communicate with an advanced graphics port (AGP) 114 via a graphics bus 116.

MCH 106 communicates with an I/O controller hub (ICH) 118, also known as a South bridge, via a peripheral component interconnect (PCI) bus 120. ICH 118 may be coupled to one or more I/O (Input/Output) component devices, such as, but not limited to, a network interface controller (NIC) 122 via a PCI bus 134, and a microphone 124 and a speaker 126, both via an audio codec 136. NIC 122, microphone 124, and speaker 126 are shown in phantom (grayed out) as well as in reality to indicate that these devices, which would normally be known to, and used by, a single partition, yet hidden from all remaining partitions, are now being exposed to the hidden partitions so that these devices may be shared across partitions.

Although other types of I/O component devices may be used, NIC 122, microphone 124, and speaker 126 were chosen as exemplary I/O component devices for illustrating interleaved access and time-based access to I/O component devices according to embodiments of the present invention. One skilled in the relevant art(s) would know that other I/O component devices capable of providing interleaved or time-based access may be used as well.

Core processors 0-3 may be IA64 (Itanium) processors manufactured by Intel Corporation, located in Santa Clara, Calif., or any other type of processors capable of carrying out the methods disclosed herein. Although FIG. 1 shows four core processors on a single socket, the invention is not limited to four core processors on a single socket. In other embodiments there may be more than four core processors on a single socket or less than four core processors on a single socket. One or more of the core processors may include multiple threads as well.

As previously indicated memory 110 is partitioned into two parts, Mem 1 and Mem 2 for use by main partition 102 and sequestered partition 104, respectively. Memory 110 may be a hard disk, a floppy disk, random access memory (RAM), read only memory (ROM), flash memory, or any other type of medium readable by core processors 0-3. Memory 110 may store instructions for performing the execution of method embodiments of the present invention.

Nonvolatile memory, such as Flash memory 128, may be coupled to ICH 118 via a SPI (System Parallel Interface) bus 130. In embodiments of the present invention, BIOS firmware may reside in Flash memory 132 and at boot up of the platform, instructions stored on Flash memory 132 will be executed. In an embodiment, Flash memory 132 may also store instructions for performing the execution of method embodiments described herein.

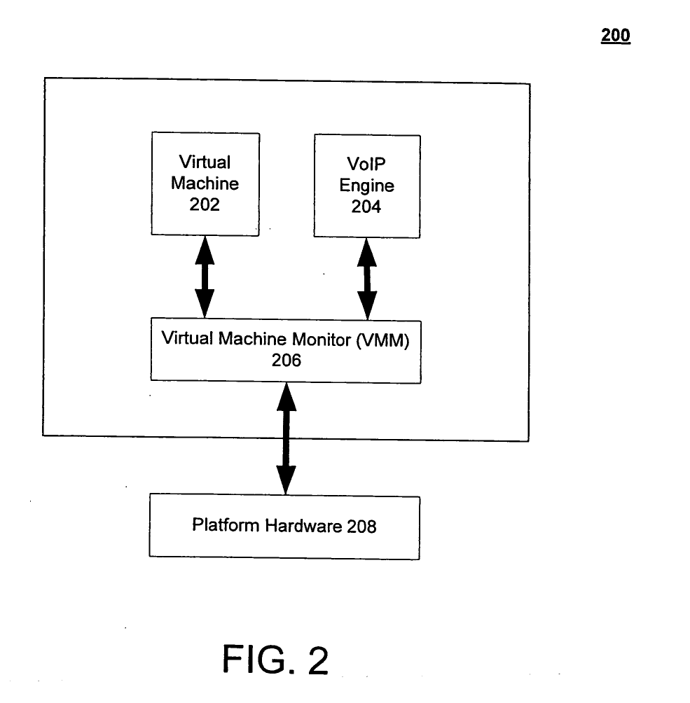

As previously indicated, embodiments of the present invention allow resources to be shared across partitions. In other words, resources need not be solely dedicated to any one partition. They can be utilized across partitions. In other words, devices that may have been solely dedicated to one partition are now exposed to other partitions for use by those partitions as well. This is accomplished by providing a mechanism such as a resource arbiter 128, shown as part of ICH 118, to manage usage of the I/O component devices (also referred to as resources) attached to ICH 118. Resource arbiter 128 acts as a traffic cop to maintain the integrity of the component devices while ensuring priority use by any designated partition, such as, for example, sequestered partition 104. Thus, resource arbiter 128 enables each of component devices 122, 124, and 126, to be shared by each of partitions 102 and 104 in a seamless manner. Although resource arbiter 128 is shown as being part of ICH 118, in reality the code or firmware for resource arbiter 128 may reside within a partition, such as, for example, sequestered partition 104 in FIG. 1. In a virtualization environment, the code or firmware for resource arbiter 128 may reside in VMM 206 in FIG. 2.

In embodiments, access to certain devices, such as NIC 122, may be interleaved amongst partitions to give the impression of a partition dedicated resource. These devices may be referred to as interleaved I/O devices. For example, access to NIC 122 may be shared by partitions 102 and 104 in a manner such that neither partition encounters a long wait time. NIC 122, which allows for packet-based transmissions that occur over short periods of time (i.e., milliseconds), allows resource arbiter 128 to schedule transmissions from both partitions at the same time, interleaving one or more blobs of data from partition 102 between one or more blobs of data from partition 104. Neither partition recognizes any significant delay in the transmission of its data because it does not take a long time for NIC 122 to send a blob of data across the network.

In embodiments, access to certain devices, such as microphone 124 and speaker 128, may be time-based to allow use of the I/O device by one partition at a time. These devices may be referred to as time-based latched I/O devices. For example, access to a microphone or a speaker requires, in most instances, more than a second, therefore, if more than one partition requests access to a time-based I/O device, resource arbiter 128 must act as a traffic cop in deciding which partition is given immediate access to the device and which partition must be queued up to get access to the device at a later time.

Resource arbiter 128 also allows prioritized use of an I/O device to handle critical events. The sharing of devices across partitions in a manner that allows prioritized use of a device for critical events lessens, and in some cases eliminates, the need for I/O device redundancy.

Resource arbiter 128 may be implemented in a variety of ways. As shown in FIG. 1, core 0 of socket 1 for main partition 102 might be requesting access to a device at approximately the same time core 2 of socket 3 for sequestered partition 104 is requesting access to a device. Resource arbiter 128 will receive the requests and act as a traffic cop in providing access to the requested device(s). When a request from a partition is made to resource arbiter 128 to access a device that is not already in use, resource arbiter 128 will grant the partition access to that device.

When a request from a partition is made to resource arbiter 128 to access a device that is already in use, resource arbiter 128 will determine whether the device is an interleaving device, and if so, resource arbiter 128 will interleave access to the device for both partitions. If the device is a time-based device, and the partition requesting access to the device has a higher priority than the partition presently using the device, the requesting partition may preempt use of the device. If the requesting partition has a high enough priority to preempt use of the device, resource arbiter 128 will give the current partition that is using the device a timeout and enable the requesting partition to communicate with the device. The partition given a timeout may complete its transmission after the higher priority device has finished using the device. If the requesting partition does not have a higher priority than the partition in use of the device to preempt use of the device, resource arbiter 128 will give the requesting partition a timeout and the request may be queued up for access to the device at a later time. Thus, the present invention allows multiple partitions to be able to access a single device safely and allow preemptions such that if there is a higher priority partition, the higher priority partition may take control over the device while the partition having less priority may be temporarily put off line.

In one embodiment, partitions with higher priority may also be given more access time to use a device. For example, one partition may be given access to a device 90% of the time while the remaining time is split amongst the other or remaining partitions. In this instance, access to a device by these other partitions will slow down significantly. For example, if sequestered partition 104 is given access to NIC 122 90% of the time, interleaved access for main partition 102 will occur 10% of the time, thereby significantly increasing the delay seen by main partition 102 in accessing NIC 122.

Embodiments of the present invention can also be implemented in a virtualized environment. FIG. 2 is a block diagram implementation of an embodiment of the present invention in a virtualized environment. Block diagram 200 shows a virtual machine 202 and a VOIP engine 204, both of which are coupled to a virtual machine monitor 206. Virtual machine monitor 206 is also coupled to platform hardware 208, which may be similar to platform 100, except in a virtualization environment, resource arbiter 128 is performed by VMM 206.

Virtual machine 202 may be a virtualized processor, such as, but not limited to, an Intel Xeon processor manufactured by Intel® Corporation located in Santa Clara, Calif. Virtual machine 202 includes a guest operating system and associated application software that can be executed on virtual machine 202. In an embodiment, the guest operating system of virtual machine 202 may not know anything about VOIP engine 204, and vice versa. In an embodiment, one or more virtual machines may be used, with each virtual machine operating on the same host machine.

VOIP engine 204 allows telephony usage over an IP (Internet Protocol) network through the digitization and packetization of voice transmissions. VOIP engine 204 converts analog voice signals to digital signals. The digital signals are then compressed and translated into digital packets for transmission over the Internet to a receiver. The receiver can then decompress and depacketize the data back into an analog signal for listening over a speaker, earpiece, or any other device that enables one to hear analog signals.

Virtual Machine Monitor (VMM) 206 may be used to arbitrate access to platform resources so that these resources can be shared across partitions of platform 208 in a prioritized manner as described above. VMM 206 may also be used to arbitrate access to platform resources on platform 208 among multiple OSs that are guests of VMM 206.

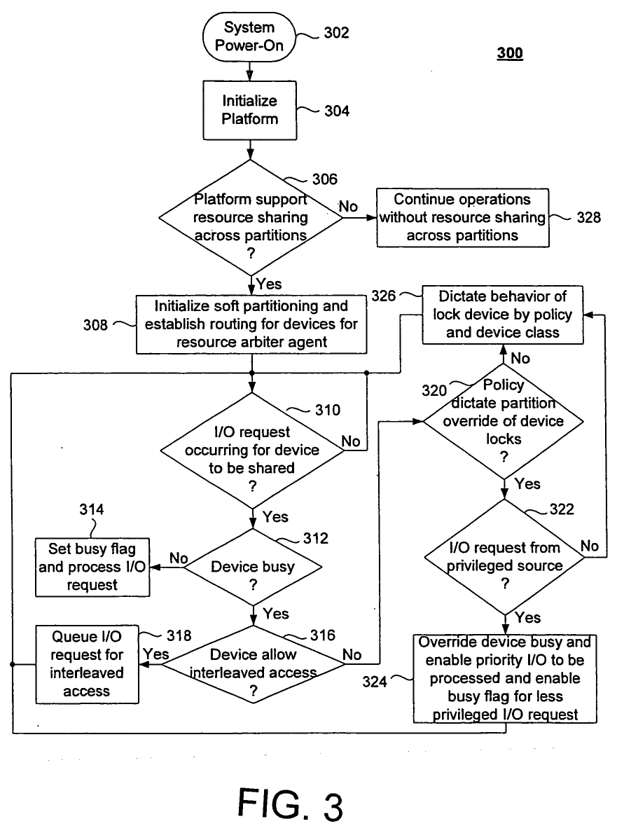

FIG. 3 is a flow diagram 300 describing an exemplary method for sharing resources in a soft-configurable partitioning environment according to an embodiment of the present invention. Flow diagram 300 provides a method that can be utilized in a virtualization environment as well as for I/O rerouting on a PRL (Platform Resource Layer) environment. The invention is not limited to the embodiment described herein with respect to flow diagram 300. Rather, it will be apparent to persons skilled in the relevant art(s) after reading the teachings provided herein that other functional flow diagrams are within the scope of the invention. The process begins with system power-on at block 302, where the process immediately proceeds to block 304.

In block 304, the platform initializes its underlying infrastructure in a manner well known to those skilled in the relevant art(s). The process then proceeds to decision block 306.

In decision block 306, it is determined whether the platform supports resource sharing across partitions. If the platform does support resource sharing across partitions, the process proceeds to block 308.

In block 308, partitioning of the platform is initialized and routing is established for all I/O devices in question so that I/O device requests will be routed to the resource arbitrator agent. This includes determining how many soft partitions will there be, what core processors are associated with a partition, what resources are associated with a partition (i.e., resource enumeration), what I/O devices are connected to the platform, what memory ranges are associated with a partition, etc. In other words, the soft partitioning infrastructure is defined on a per partition basis. In one embodiment, this may be determined by firmware resident in the chipset (i.e., MCH and ICH). The process then proceeds to decision block 310.

In decision block 310, it is determined whether an I/O request is occurring for a device that is intended to be shared across partitions. If an I/O request is not occurring for a device that is intended to be shared across partitions, the process remains at block 310. If it is determined that an I/O request is occurring for a device that is intended to be shared, the process proceeds to decision block 312.

In decision block 312, it is determined by the resource arbiter agent whether the device associated with the I/O request is busy. The device is considered to be busy if the device is presently in use. If it is determined that the device associated with the I/O request is not busy, then the process proceeds to block 314.

In block 314, a busy flag is set for the device in question and its source. To set the busy flag for the device, the resource arbiter will set an internal state bit to indicate that the device is now in use. Once the busy flag is set, the I/O request is processed accordingly. Upon completion of the I/O request the internal state bit is cleared to acknowledge that the device is no longer in use. The process then proceeds back to decision block 310 to determine whether another I/O request is occurring for a device that is intended to be shared.

Returning to decision block 312, if it is determined that the device associated with the I/O request is busy; the process then proceeds to decision block 316. In decision block 316, it is determined whether the device associated with the I/O request allows for interleaved accesses. If the target device does allow for interleaved accesses, the process proceeds to block 318.

In block 318, the I/O request is queued up so that the I/O request can be properly interleaved as soon as the current request is complete. The process then proceeds back to decision block 310 to determine whether another I/O request is occurring for a device that is intended to be shared.

Returning to decision block 316, if it is determined that the target device does not allow for interleaved accesses, the process proceeds to decision block 320. In decision block 320, it is determined whether platform policy dictates that a high priority partition override device locks. As indicated above, one or more partitions may have high priority status. An example of a higher priority partition may be a partition dedicated to embedded IT. An embedded IT partition usually has priority over the common user in order to manage the system. If it is determined that platform policy dictates that the higher priority partition override device locks, then the process proceeds to decision block 322.

In decision block 322, it is determined whether the I/O request is from a privileged source (i.e., a partition having a higher priority than the current partition already using the device). If the I/O request is from a privileged source, then the process proceeds to block 324.

In block 324, the device busy is overridden to enable the current I/O request to be processed. A busy flag will now be enabled for the remaining outstanding I/O request for the alternate or less privileged source. Thus, the I/O request that was currently being serviced by the device for the less privileged partition is stopped and given a busy indication or a timeout, and the I/O request from the privileged source is now serviced. Upon completion of the I/O request for the privileged source, the busy flag will be cleared. When the less privileged source receives a busy indication or a timeout, a retry may be attempted for that I/O request to complete the I/O transaction for the less privileged source. The process therefore proceeds back to block 310 where it determines whether an I/O request is occurring for a device that is intended to be shared.

Returning to decision block 322, if it is determined that the I/O request is not from a privileged source, the process then proceeds to block 326. Returning to decision block 320, if it is determined that platform policy does not dictate that a privileged source override device locks, the process proceeds to block 326.

In block 326, policy and device class dictate the behavior of the locked device. In one embodiment, example behavior may be that the I/O request may be queued up. In another embodiment, example behavior may be to return a busy error. In yet another embodiment, example behavior may be that cached state information is passed back to the requester. Much of what occurs in this block depends on the device type, request type, and platform policy. So the appropriate behavior may be platform specific and/or target device specific because some devices behave differently than others. Some devices are more or less sensitive to timing. For example, NIC 122 is less sensitive to timing while microphone 124 and speaker 126 are very sensitive to timing. The process then proceeds back to decision block 310 where it is determined whether an I/O request is occurring for a device that is intended to be shared.

Returning back to decision block 306, if it is determined that the platform does not support resource sharing across partitions, the process then proceeds to block 328. In block 328, the platform continues to operate in a well known manner that does not enable resource sharing across partitions.

Embodiments of the present invention may be implemented using hardware, software, or a combination thereof and may be implemented in one or more computer systems, as shown in FIG. 1, or other processing systems. The techniques described herein may find applicability in any computing, consumer electronics, or processing environment. The techniques may be implemented in programs executing on programmable machines such as mobile or stationary computers, personal digital assistants, set top boxes, cellular telephones and pagers, consumer electronics devices (including DVD (Digital Video Disc) players, personal video recorders, personal video players, satellite receivers, stereo receivers, cable TV receivers), and other electronic devices that may include at least one processor core, a storage medium accessible by the processor core (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various system configurations, including multiprocessor systems, minicomputers, mainframe computers, independent consumer electronics devices, and the like. The invention can also be practiced in distributed computing environments where tasks or portions thereof may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods. The term “machine accessible medium” used herein shall include any medium that is capable of storing or encoding a sequence of instructions for execution by the machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system to cause the processor to perform an action or produce a result.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. A method of sharing resources across partitions, comprising:
enabling I/O (Input/Output) requests from the partitions to be routed to a resource arbiter, the resource arbiter
receiving, from a partition, an I/O request for a device to be shared across partitions;
determining whether the device associated with the I/O request is busy;
if the device is not busy, setting a busy flag for the device and processing the I/O request; and
if the device is busy, determining whether the device allows for interleaved access, wherein if the device allows for interleaved access, then queuing the I/O request so that the I/O request can be processed using interleaved access.

2. The method of claim 1, wherein if the device does not allow for interleaved access, and platform policy dictates partition overrides of device locks based on priority rankings of the partition, overriding the busy signal of the device and processing the I/O request if the requesting partition has a higher priority ranking.

3. The method of claim 1, wherein if the device does not allow for interleaved access, and the platform policy dictates partition overrides of device locks based on priority rankings of the partition, and the requesting partition does not have a higher priority ranking, then queuing the I/O request.

4. The method of claim 1, wherein if the device does not allow for interleaved access, and the platform policy dictates partition overrides of device locks based on priority rankings of the partition, and the requesting partition does not have a higher priority ranking, then returning a busy error to the partition.

5. The method of claim 1, wherein if the device does not allow for interleaved access, and the platform policy dictates partition overrides of device locks based on priority rankings of the partition, and the requesting partition does not have a higher priority ranking, then passing back to the partition cached state information.

6. The method of claim 1, wherein if the device does not allow for interleaved access, and the platform policy dictates partition overrides of device locks based on priority rankings of the partition, and the requesting partition does not have a higher priority ranking, then servicing the request based on device type, request type, and platform policy.

7. The method of claim 1, wherein if the device does not allow for interleaved access, and platform policy does not dictate partition overrides of device locks based on priority rankings of the partition, then queuing the I/O request.

8. The method of claim 1, wherein if the device does not allow for interleaved access, and platform policy does not dictate partition overrides of device locks based on priority rankings of the partition, then returning a busy error to the partition.

9. The method of claim 1, wherein if the device does not allow for interleaved access, and platform policy does not dictate partition overrides of device locks based on priority rankings of the partition, then passing back to the partition cached state information.

10. The method of claim 1, wherein if the device does not allow for interleaved access, and platform policy does not dictate partition overrides of device locks based on priority rankings of the partition, then servicing the request based on device type, request type, and platform policy.

11. The method of claim 1, wherein enabling the I/O (Input/Output) requests from the partitions to be routed to the resource arbiter includes initializing soft partitioning of the platform.

12. An article comprising: a storage medium having a plurality of machine accessible instructions, wherein when the instructions are executed by a processor, the instructions provide for enabling I/O (Input/Output) requests from the partitions to be routed to a resource arbiter, the resource arbiter
receiving, from a partition, an I/O request for a device to be shared across partitions;
determining whether the device associated with the I/O request is busy;
if the device is not busy, setting a busy flag for the device and processing the I/O request; and
if the device is busy, determining whether the device allows for interleaved access, wherein if the device allows for interleaved access, then queuing the I/O request so that the I/O request can be processed using interleaved access.

13. The article of claim 12, wherein if the device does not allow for interleaved access, and platform policy dictates partition overrides of device locks based on priority rankings of the partition, the instructions further comprising overriding the busy signal of the device and processing the I/O request if the requesting partition has a higher priority ranking.

14. The article of claim 12, wherein if the device does not allow for interleaved access, and the platform policy dictates partition overrides of device locks based on priority rankings of the partition, and the requesting partition does not have a higher priority ranking, the instructions further comprising queuing the I/O request.

15. The article of claim 12, wherein if the device does not allow for interleaved access, and the platform policy dictates partition overrides of device locks based on priority rankings of the partition, and the requesting partition does not have a higher priority ranking, the instructions further comprising returning a busy error to the partition.

16. The article of claim 12, wherein if the device does not allow for interleaved access, and the platform policy dictates partition overrides of device locks based on priority rankings of the partition, and the requesting partition does not have a higher priority ranking, the instructions further comprising passing back to the partition cached state information.

17. The article of claim 12, wherein if the device does not allow for interleaved access, and the platform policy dictates partition overrides of device locks based on priority rankings of the partition, and the requesting partition does not have a higher priority ranking, the instructions further comprising servicing the request based on device type, request type, and platform policy.

18. The article of claim 12, wherein if the device does not allow for interleaved access, and platform policy does not dictate partition overrides of device locks based on priority rankings of the partition, the instructions further comprising queuing the I/O request.

19. The article of claim 12, wherein if the device does not allow for interleaved access, and platform policy does not dictate partition overrides of device locks based on priority rankings of the partition, the instructions further comprising returning a busy error to the partition.

20. The article of claim 12, wherein if the device does not allow for interleaved access, and platform policy does not dictate partition overrides of device locks based on priority rankings of the partition, the instructions further comprising passing back to the partition cached state information.

21. The article of claim 12, wherein if the device does not allow for interleaved access, and platform policy does not dictate partition overrides of device locks based on priority rankings of the partition, the instructions further comprising servicing the request based on device type, request type, and platform policy.

22. The article of claim 12, wherein enabling the I/O (Input/Output) requests from the partitions to be routed to the resource arbiter includes instructions for initializing soft partitioning of the platform.

23. A system for sharing resources, comprising:
a virtual machine;
a virtual machine monitor (VMM) coupled to the virtual machine; and
a platform coupled to the VMM, the platform including a first partition and a second partition, each partition including a plurality of I/O devices;
wherein the VMM to arbitrate access to the plurality of I/O devices across the first and second partitions of the platform in a prioritized manner.

24. The system of claim 23, wherein when the VMM receives an I/O request for an interleaved device already in use by the first partition, the VMM to arbitrate access to the interleaved device currently in use by the first partition by interleaving access to the second partition.

25. The system of claim 23, wherein when the VMM receives an I/O request from the second partition for an I/O device already in use by the first partition, the VMM to determine if the second partition has a higher priority rank than the first partition, and if so, the VMM to override use of the I/O device by the first partition to enable the second partition use the I/O device.

26. The system of claim 23, wherein each of the first and second partitions include multi-core processors on a single socket.

27. A system for sharing resources, comprising:
a platform having at least two partitions;
a plurality of I/O (input/output) devices coupled to the platform, each of the I/O devices located in one of the at least two partitions, yet exposed to the other partition; and
a resource arbiter, the resource arbiter to receive I/O requests from the at least two partitions and act as a traffic cop to arbitrate access to the plurality of I/O devices across the at least two partitions of the platform in a prioritized manner.

28. The system of claim 27, wherein each of the at least two partitions includes multi-core processors on a single socket.

29. The system of claim 27, wherein when the resource arbiter receives an I/O request for an interleaved device already in use by one of the at least two partitions, the resource arbiter to arbitrate access to the interleaved device currently in use by the one of the at least two partitions by interleaving access to both of the at least two partitions.

30. The system of claim 27, wherein when the resource arbiter receives an I/O request from one of the at least two partitions for an I/O device already in use by another of the at least two partitions, the resource arbiter to determine if the one of the at least two partitions has a higher priority rank than the other of the at least two partitions, and if so, the resource arbiter to override use of the I/O device by the one of the at least two partitions to enable the other of the at least two partitions to use the I/O device.
